(19) United States
(12) Patent Application Publication
(10) Pub. No.: US 2023/0234477 A1
(43) Pub. Date: Jul. 27, 2023

(54) SEAT CONTROL DEVICE AND SEAT CONTROL METHOD

(71) Applicants: Koji OZAWA, Aichi (JP); Yota KATAYAMA, Aichi (JP); Hidekazu IMAI, Aichi (JP)

(72) Inventors: Koji OZAWA, Aichi (JP); Yota KATAYAMA, Aichi (JP); Hidekazu IMAI, Aichi (JP)

(73) Assignee: NIDEC MOBILITY CORPORATION, Aichi (JP)

(21) Appl. No.: 18/160,257

(22) Filed: Jan. 26, 2023

(30) Foreign Application Priority Data
Jan. 27, 2022 (JP) 2022-010682

(51) Int. Cl. B60N 2/02

(52) U.S. Cl. CPC B60N 2/0248; B60N 2002/0268

(57) ABSTRACT

A seat control device includes: a control unit configured to control movement of an electric seat; and a seating detection unit configured to detect whether an occupant is seated on another seat. When the electric seat moves in a direction of the other seat, in a case in which the occupant seated on the other seat is detected, the control unit moves the electric seat in the direction of the other seat in a first control mode including a process for suppressing the occupant from being pinched between the electric seat and the other seat. When the electric seat moves in the direction of the other seat, in a case in which no occupant seated on the other seat is detected, the control unit moves the electric seat in the direction of the other seat in a second control mode not including the process.

### CROSS-REFERENCE TO RELATED APPLICATIONS

This application is based upon and claims the benefit of priority from Japanese Patent Application No. 2022-010682, filed on Jan. 27, 2022; the entire contents of which are incorporated herein by reference.

### FIELD

One or more embodiments of the present invention relate to a seat control device configured to control an electric seat equipped in a vehicle or the like.

### BACKGROUND

Some vehicles such as four-wheeled motor vehicles are equipped with an electric seat in which a seat portion and a backrest portion are moved back and forth by rotation of a motor. In such a seat, when adjusting the positions of the seat portion and the backrest portion, in a related art, the positions are adjusted by operating an operation unit provided near the seat. On the other hand, in recent years, a vehicle is introduced with an automatic driving function of registering the position of the seat portion or backrest portion in advance as a target position in accordance with a user's preference and automatically moving the seat portion and backrest portion to the target position when the user gets in the vehicle.

In a vehicle with such an automatic driving function, for example, in a state in which there is a person or object between the front seat and the rear seat, when the seat portion of the front seat is automatically moved backward (straight forward), it is unsafe that the person or object is pinched between the front seat and the rear seat. The same applies to the case in which the backrest portion of the front seat automatically moves (tilts) backward. Therefore, the seat control device has a function of detecting pinching and reversing the seat portion or the backrest portion in the direction opposite to the movement direction.

When pinching occurs, the current flowing through the motor increases and the rotation speed of the motor decreases as the load applied to the motor increases. Therefore, it is possible to determine whether or not pinching has occurred by detecting the amount of change (difference) in the current or rotation speed of the motor in a predetermined period and comparing the detected value with a threshold value. KR10-2020-0065312A, KR10-2020-0065302A, KR10-2013-0039104A, CN109278594A, JP2016-129449A, and JP2007-131138A discloses a pinching detection technique in seat position control. JP2004-210159A describes a control method of a seat position when pinching is detected, which occurs when a seat cushion is flipped up. JP2021-095085A describes a technique for preventing a seat from becoming incapable of being driven by increasing a threshold value for detection of pinching in a case in which an occupant is seated on a seat.

FIGS. 9A to 9C and FIGS. 10A to 10C show basic operations in a case in which pinching caused by an electric seat 30 has occurred. The electric seat 30 includes a seat portion 31 that can move straight in the front-and-rear direction, and a backrest portion 32 that can tilt in the front-and-rear direction. The arrow F indicates the forward direction, and the arrow R indicates the backward direction. Hereinafter, the straight operation of the seat portion 31 in the front-and-rear direction will be referred to as a “sliding operation”, and the tilting operation of the backrest portion 32 in the front-and-rear direction will be referred to as a “reclining operation”.

FIGS. 9A to 9C show cases in which pinching has occurred during the sliding operation of the seat portion 31. FIG. 9A shows the state before the sliding operation, in which the front electric seat (here, the driver's seat) 30 on which an occupant 50 is seated is positioned at a certain distance from a rear seat 40 on which an occupant 60 is seated. The seat 40 is a fixed seat here, but may be an electric seat (the same applies hereinafter).

In this state, when the occupant 50 performs an automatic operation to automatically move the seat portion 31 to a predetermined position (target position) in the backward direction R, the seat portion 31 moves in the P direction by the sliding operation as shown in FIG. 9B, and the backrest portion 32 also moves in conjunction with the seat portion 31. That is, the entire electric seat 30 moves in the backward direction R. At this time, if the target position is close to the rear seat 40, a part of the electric seat 30 that is moving hits the legs of the occupant 60 on the rear seat, as indicated by the dashed line a. As a result, the electric seat 30 cannot move any further, and the legs are pinched between the seats 30 and 40. When this pinching is detected, the motor temporarily stops in the state in FIG. 9B, and then rotates in reverse. Therefore, the seat portion 31 of the electric seat 30 is reversed from the position of FIG. 9B and moves in the P′ direction opposite to the P direction as shown in FIG. 9C. As a result, the space between the seats 30 and 40 is widened, and the legs of the occupant 60 are recovered from the pinching.

FIGS. 10A to 10C show cases in which pinching has occurred during the reclining operation of the backrest portion 32. FIG. 10A shows the state before the reclining operation, and the front electric seat 30 (driver's seat) on which the occupant 50 is seated is positioned at a certain distance from the rear seat 40.

In this state, when the occupant 50 performs an automatic operation to automatically move the backrest portion 32 to a predetermined position (target position) in the backward direction R, the backrest portion 32 moves in the Q direction by the reclining operation as shown in FIG. 10B (the seat portion 31 does not move). At this time, if the tilt angle of the backrest portion 32 is equal to or greater than a certain value, the backrest portion 32 that is moving hits the legs of the occupant 60 on the rear seat as indicated by the dashed line b. As a result, the backrest portion 32 cannot move any further, and the legs are pinched between the seats 30 and 40. When this pinching is detected, the motor temporarily stops in the state in FIG. 10B, and then rotates in reverse. Therefore, the backrest portion 32 is reversed from the position of FIG. 10B and moves in the Q′ direction opposite to the Q direction as shown in FIG. 10C. As a result, the space between the seats 30 and 40 is widened, and the legs of the occupant 60 are recovered from the pinching.

### SUMMARY

As described above, when pinching has occurred between the front and rear seats 30 and 40, it is possible to recover from the pinching by reversing the seat portion 31 and the backrest portion 32 in the opposite direction. However, since this reversing operation is a subsequent operation performed after pinching has actually occurred, the reversing operation does not provide a fundamental solution to the problem that the safety of the occupant is threatened due to pinching.

An object of one or more embodiments of the present invention is to provide a seat control device that can secure safety by reducing the occurrence of pinching of an occupant.

A seat control device according to one or more embodiments of the present invention includes a control unit configured to control movement of an electric seat in a front-and-rear direction, and a seat control device configured to detect whether or not an occupant is seated on another seat in front of or behind the electric seat, the other seat being adjacent to the electric seat. When the electric seat moves in a detection of the other seat, in a case in which the seating detection unit detects that the occupant is seated on the other seat, the control unit moves the electric seat in the direction of the other seat in a first control mode including a process for suppressing the occupant from being pinched between both the seats. Further, when the electric seat moves in the direction of the other seat, in a case in which the seating detection unit does not detect that the occupant is seated on the other seat, the control unit moves the electric seat in the direction of the other seat in a second control mode not including the process.

With this configuration, in a case in which the occupant is seated on the other seat adjacent to the electric seat, since the process for suppressing the pinching of the occupant is executed in the first control mode, the occurrence of pinching of the occupant between both the seats can be reduced. On the other hand, if no occupant is seated on the other seat adjacent to the electric seat, the occupant is not likely to be pinched even if the electric seat is moved in the second control mode not including the above process.

In one or more embodiments of the present invention, the control unit may include a first control unit configured to control an operation of a seat portion that is provided in the electric seat and configured to move straight in the front-and-rear direction. In this case, the first control unit moves the seat portion in the direction of the other seat by a distance smaller than a predetermined distance as the first control mode, and moves the seat portion in the direction of the other seat by the predetermined distance as the second control mode.

In one or more embodiments of the present invention, the control unit may include a second control unit configured to control the operation of the backrest portion that is provided in the electric seat and configured to tilt in the front-and-rear direction. In this case, the second control unit moves the backrest portion by an angle smaller than a predetermined angle in the direction of the other seat as the first control mode, and moves the backrest portion by the predetermined angle in the direction of the other seat as the second control mode.

In one or more embodiments of the present invention, an alarm command output unit may be provided for issuing an alarm to the occupant seated on the other seat. Further, the control unit may include a first control unit configured to control an operation of a seat portion that is provided in the electric seat and configured to move straight in the front-and-rear direction. In this case, the first control unit moves the seat portion in the direction of the other seat in a state in which an alarm is issued by the alarm command output unit as the first control mode, and moves the seat portion in the direction of the other seat without issuing an alarm by the alarm command output unit as the second control mode.

Further, in a case in which the above-described alarm command output unit is provided, the control unit may include a second control unit configured to control the operation of the backrest portion that is provided in the electric seat and configured to tilt in the front-and-rear direction. In this case, the second control unit moves the backrest portion in the direction of the other seat in a state in which an alarm is issued by the alarm command output unit as the first control mode, and moves the backrest portion in the direction of the other seat without issuing an alarm by the alarm command output unit as the second control mode.

According to one or more embodiments of the present invention, in a case in which the occupant is seated the other seat adjacent to the electric seat, since the process for suppressing the pinching of the occupant is executed by the movement of the electric seat, and in a case in which the occupant is not seated on the other seat, since the occupant is not likely to be pinched, the safety of the occupant is secured by reducing the occurrence of pinching.

### BRIEF DESCRIPTION OF DRAWINGS

FIG. 1 is a block diagram showing a first embodiment of the present invention;

FIGS. 2A to 2C are diagrams showing an operation of the first embodiment;

FIGS. 3A to 3C are diagrams showing another operation of the first embodiment;

FIG. 4 is a flow chart showing a control procedure of the first embodiment;

FIG. 5 is a block diagram showing a second embodiment of the present invention;

FIGS. 6A to 6C are diagrams showing an operation of a second embodiment;

FIGS. 7A to 7C are diagrams showing another operation of the second embodiment;

FIG. 8 is a flow chart showing a control procedure of the second embodiment;

FIGS. 9A to 9C are diagrams for describing pinching due to movement of a seat portion; and

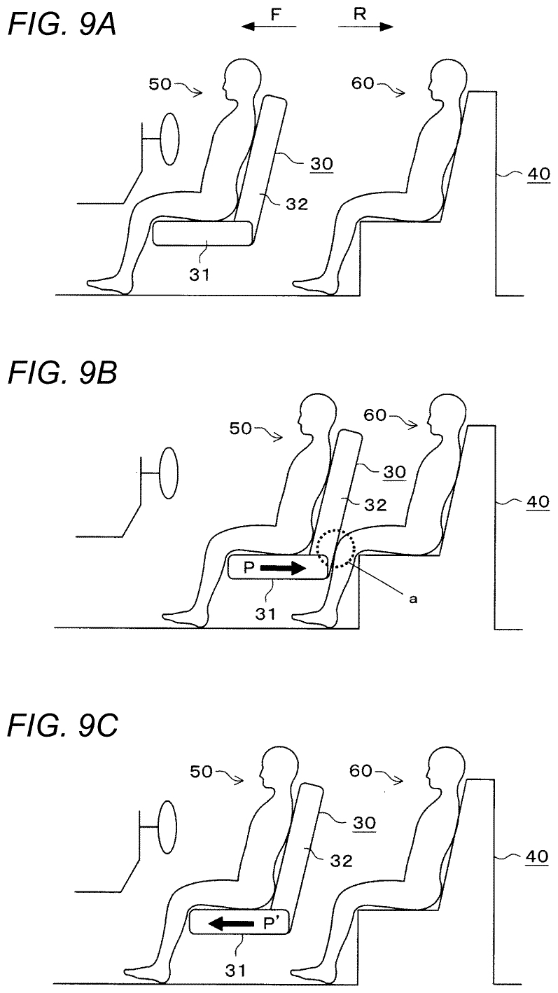

FIGS. 10A to 10C are diagrams for describing pinching due to the movement of a backrest portion.

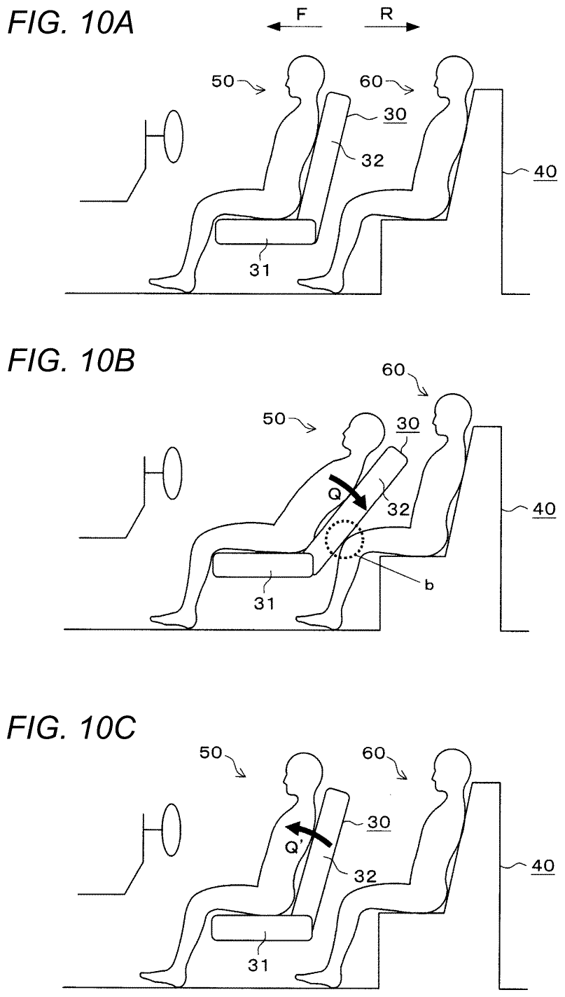

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention. Embodiments of the present invention will be described with reference to drawings. The same reference numerals are used throughout the drawings to refer to the same or corresponding parts. In the following, an example in which a seat control device mounted on a vehicle will be given.

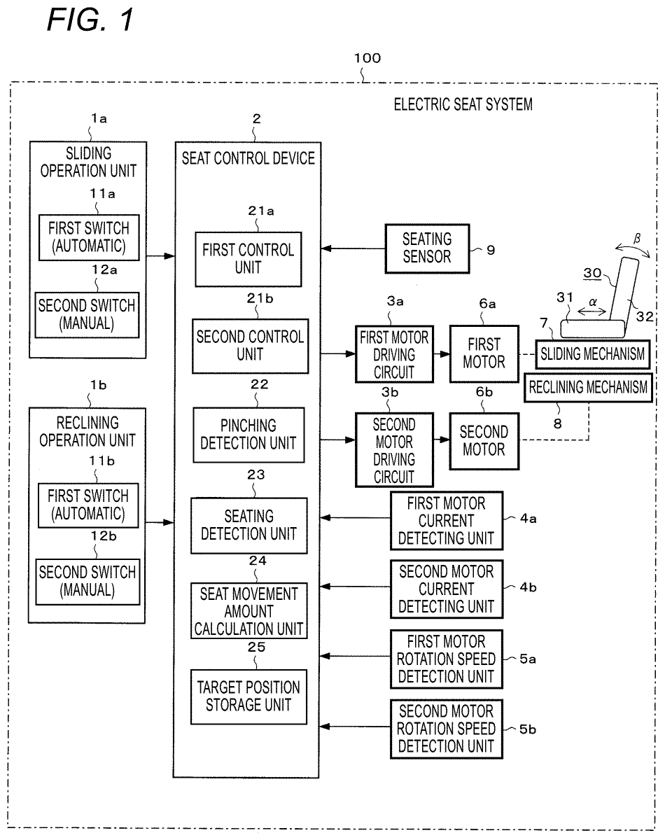

FIG. 1 shows a seat control device 2 according to a first embodiment of the present invention and an electric seat system 100 using the same. The electric seat system 100 is installed in a vehicle such as a four-wheeled motor vehicle. The electric seat system 100 includes a sliding operation unit 1a, a reclining operation unit 1b, a seat control device 2, a first motor driving circuit 3a, a second motor driving circuit 3b, a first motor current detecting unit 4a, a second motor current detecting unit 4b, a first motor rotation speed detection unit 5a, a second motor rotation speed detection unit 5b, a first motor 6a, a second motor 6b, a sliding mechanism 7, a reclining mechanism 8, a seating sensor 9, and an electric seat 30.

The sliding operation unit 1a is provided with two switches 11a and 12a. The first switch 11a is an automatic drive switch that is operated when the seat portion 31 of the electric seat 30 is automatically slid to a target position in a α direction. The second switch 12a is a manual drive switch that is operated when the seat portion 31 is manually slid to an arbitrary position in the α direction.

The reclining operation unit 1b is also provided with two switches 11b and 12b. The first switch 11b is an automatic drive switch that is operated when the backrest portion 32 of the electric seat 30 is automatically reclined to a target position in a β direction. The second switch 12b is a manual drive switch that is operated when the backrest portion 32 is manually reclined to an arbitrary position in the β direction.

The seat control device 2 includes a first control unit 21a, a second control unit 21b, a pinching detection unit 22, a seating detection unit 23, a seat movement amount calculation unit 24, and a target position storage unit 25.

The first control unit 21a outputs a control signal for controlling the rotation of the first motor 6a to the first motor driving circuit 3a based on the operation state of each of the switches 11a and 12a of the sliding operation unit 1a, the detection result of the pinching detection unit 22, the detection result of the seating detection unit 23, and the movement amount of the seat portion 31 calculated by the seat movement amount calculation unit 24, and the like.

The second control unit 21b outputs a control signal for controlling the rotation of the second motor 6b to the second motor driving circuit 3b based on the operation state of each of the switches 11b and 12b of the reclining operation unit 1b, the detection result of the pinching detection unit 22, the detection result of the seating detection unit 23, and the movement amount of the backrest portion 32 calculated by the seat movement amount calculation unit 24, and the like.

The pinching detection unit 22 detects pinching of an object by the electric seat 30 based on the currents of the second motors 6a and 6b detected by the current detecting units 4a and 4b, respectively. The details of pinching detection based on the motor current are well known and will not be described.

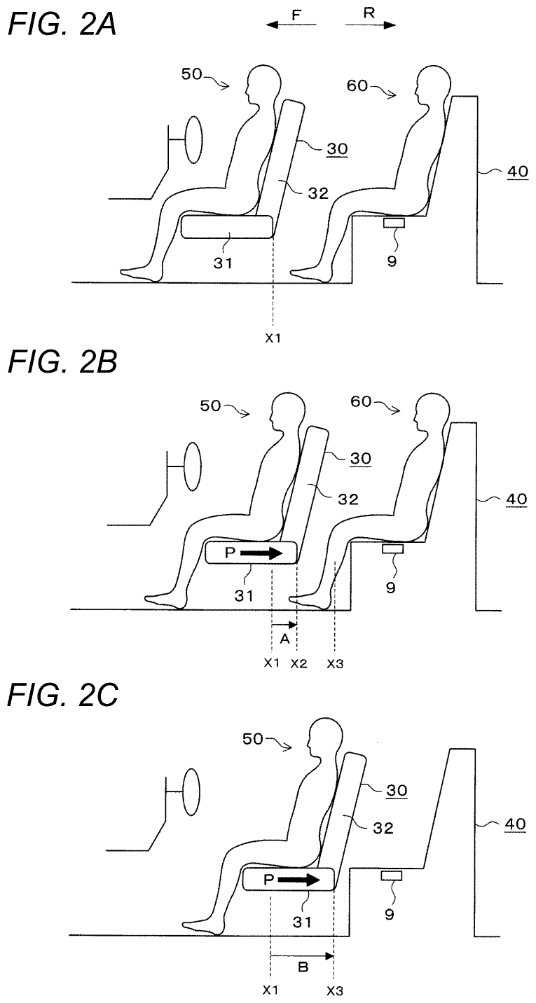

Based on the detection signal from the seating sensor 9, the seating detection unit 23 detects whether or not the occupant is seated on another seat (the seat 40 shown in FIGS. 2A to 2C) adjacent to the electric seat 30 in the front-and-rear direction.

The seat movement amount calculation unit 24 calculates the respective movement amounts of the seat portion 31 and the backrest portion 32 based on the rotation speeds of the motors 6a and 6b respectively detected by the motor rotation speed detection units 5a and 5b. The movement amount of the seat portion 31 is a distance, and the movement amount of the backrest portion 32 is an angle. The motor rotation speed detection units 5a and 5b are composed of, for example, rotation sensors that output pulse signals in synchronization with the rotation of the motors 6a and 6b.

The target position storage unit 25 stores target positions when the electric seat 30 is automatically driven by the first switches 11a and 11b of the operation units 1a and 1b. After adjusting the positions of the seat portion 31 and the backrest portion 32 to desired positions by operating the second switches 12a and 12b of the respective operation units 1a and 1b, the positions are stored in the target position storage unit 25 as target positions by operating a setting switch not shown in the drawing.

The seat control device 2 is composed of a microcomputer, and respective functions of the first control unit 21a, the second control unit 21b, the pinching detection unit 22, the seating detection unit 23, and the seat movement amount calculation unit 24 are actually realized by software, but in this case, the functions are illustrated as blocks of hardware for convenience.

The first motor driving circuit 3a generates a drive voltage for rotating the first motor 6a and supplies the drive voltage to the first motor 6a. The first motor 6a is rotated by this drive voltage, and causes the seat portion 31 of the electric seat 30 to slide in the α direction via the sliding mechanism 7. The sliding mechanism 7 is connected to the first motor 6a and the seat portion 31, and converts the rotary motion of the first motor 6a into linear motion.

The second motor driving circuit 3b generates a drive voltage for rotating the second motor 6b and supplies the drive voltage to the second motor 6b. The second motor 6b is rotated by this drive voltage, and causes the backrest portion 32 of the electric seat 30 to recline in the β direction via the reclining mechanism 8. The reclining mechanism 8 is connected to the second motor 6b and the backrest portion 32, and transmits the rotation of the second motor 6b to the backrest portion 32 via gears or the like. The seating sensor 9 is provided in the rear seat 40 as shown in FIGS. 2A to 2C, and outputs a detection signal corresponding to whether or not the occupant 60 is seated. A pressure sensor, for example, can be used as the seating sensor 9.

Next, the details of the control in the above-described first embodiment will be described with reference to FIGS. 2A to 4.

FIGS. 2A to 2C show the operation in a case in which the seat portion 31 of the electric seat 30 moves. FIG. 2A shows the state before the sliding operation, in which the front electric seat 30 on which the occupant 50 is seated is positioned at a certain distance from the rear seat 40 on which the occupant 60 is seated. The position of the seat portion 31 at this time (here, the rear end position) is defined as X1. X1 is expressed as a distance from a reference position. The reference position is, for example, the position of the end of the rail provided in the sliding mechanism 7 (FIG. 1). The same applies to X2 and X3, which will be described later.

In this state, when the occupant 50 operates the first switch 11a of the sliding operation unit 1a, the seat portion 31 moves toward the target position by the reclining operation. At this time, if the movement direction of the seat portion 31 is the backward direction R, that is, the direction of the rear seat 40, the modes of control differ depending on whether or not the occupant 60 is seated on the seat 40.

More specifically, as shown in FIG. 2B, in a case in which the occupant 60 is seated on the rear seat 40, a seating detection signal is output from the seating sensor 9, and the seating detection unit 23 detects that the occupant 60 is seated on the rear seat 40 based on this signal. Then, the first control unit 21a moves the seat portion 31 of the electric seat 30 in the direction of the rear seat 40 (P direction) in accordance with a first control mode. The first control mode is a control mode that includes the process for suppressing the occupant 60 from being pinched between the seats 30 and 40.

Specifically, the first control unit 21a rotates the first motor 6a by the first motor driving circuit 3a to move the seat portion 31 by a distance A from X1 to X2 and stop the same at the position X2. Here, the distance A is set to a distance smaller than a distance B in FIG. 2C described later (A<B). Further, X2 is a position in front of the target position X3 in the P direction that is the movement direction of the seat portion 31, and a position where the occupant 60 is less likely to be pinched between the front electric seat 30 and the rear seat 40. Therefore, in a state in which the seat portion 31 is stopped at the position X2, the legs of the occupant 60 are less likely to be pinched between the seats 30 and 40.

On the other hand, in a case in which the occupant 60 is not seated on the rear seat 40 as shown in FIG. 2C, a seating detection signal is not output from the seating sensor 9, and the seating detection unit 23 does not detect that the occupant 60 is seated on the rear seat 40. Therefore, the first control unit 21a moves the seat portion 31 of the electric seat 30 in the direction of the rear seat 40 (P direction) in accordance with a second control mode. The second control mode is a control mode not including the process of pinching suppression such as the first control mode.

Specifically, the first control unit 21a rotates the first motor 6a by the first motor driving circuit 3a to move the seat portion 31 from X1 to the target position X3 by the distance B and stop the same at the target position X3. The target position X3 is a position close to the rear seat 40, but the occupant 60 is not seated on the seat 40. Therefore, pinching of the occupant 60 does not occur in a state in which the seat portion 31 is stopped at the target position X3.

As described above, in the first embodiment, in a case in which the seat portion 31 slides, if the occupant 60 is seated on the rear seat 40 as shown in FIG. 2B, since the movement distance of the seat portion 31 is limited to the short distance A, the pinching of the occupant 60 between both the seats 30 and 40 can be suppressed. On the other hand, as shown in FIG. 2C, if the occupant 60 is not seated on the rear seat 40, pinching of the occupant 60 does not occur even if the seat portion 31 moves the long distance B to the target position X3.

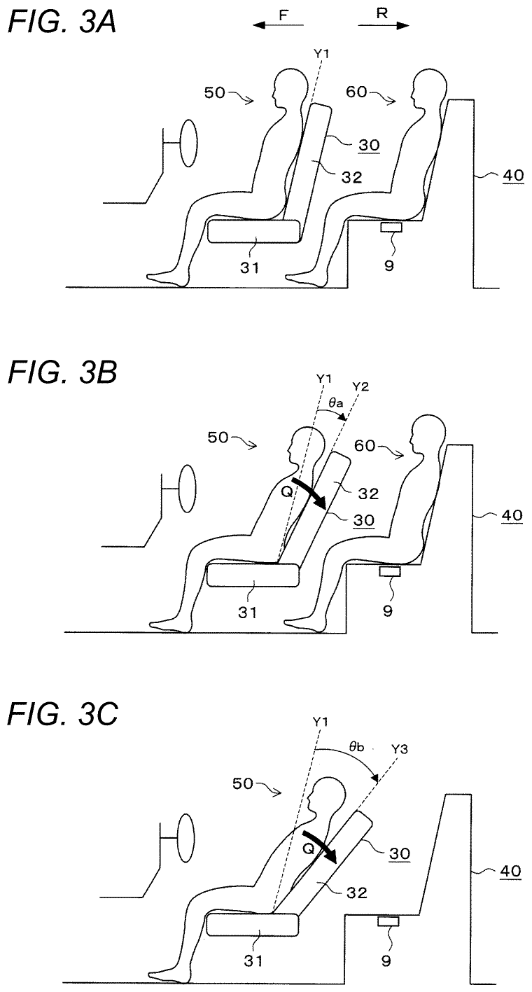

FIGS. 3A to 3C show the operation in a case in which the backrest portion 32 of the electric seat 30 moves. FIG. 3A shows the state before the reclining operation, in which the front electric seat 30 on which the occupant 50 is seated is positioned at a certain distance from the rear seat 40 on which the occupant 60 is seated. The position of the backrest portion 32 at this time is assumed to be Y1. Y1 is expressed as an angle with respect to a reference plane. The reference plane is, for example, the seat surface of the seat portion 31. The same applies to Y2 and Y3, which will be described later.

In this state, when the occupant 50 operates the first switch 11b of the reclining operation unit 1b, the backrest portion 32 moves toward the target position by the reclining operation. At this time, if the movement direction of the backrest portion 32 is the backward direction R, that is, the direction of the rear seat 40, the modes of control differ depending on whether or not the occupant 60 is seated on the seat 40.

More specifically, as shown in FIG. 3B, in a case in which the occupant 60 is seated on the rear seat 40, a seating detection signal is output from the seating sensor 9, and the seating detection unit 23 detects that the occupant 60 is seated on the rear seat 40 based on this signal. Then, the second control unit 21b moves the backrest portion 32 of the electric seat 30 in the direction of the rear seat 40 (Q direction) in accordance with the first control mode. Also in this case, the first control mode is a control mode including a process for suppressing the occupant 60 from being pinched between the seats 30 and 40.

Specifically, the second control unit 21b rotates the second motor 6b by the second motor driving circuit 3b to move the backrest portion 32 from Y1 to Y2 by an angle θa and stop the same at the Y2 position. Here, the angle θa is set smaller than an angle θb in FIG. 3C (θa<θb). Y2 is a position in front of the target position Y3 in FIG. 3C in the Q direction that is the movement direction of the backrest portion 32, and a position where the occupant 60 is less likely to be pinched between the front electric seat 30 and the rear seat 40. Therefore, in a state in which the backrest portion 32 is stopped at the Y2 position, the legs of the occupant 60 are less likely to be pinched between the seats 30 and 40.

On the other hand, as shown in FIG. 3C, in a case in which the occupant 60 is not seated on the rear seat 40, a seating detection signal is not output from the seating sensor 9, and the seating detection unit 23 does not detect that the occupant 60 is seated on the rear seat 40. Therefore, the second control unit 21b moves the backrest portion 32 of the electric seat 30 in the direction of the rear seat 40 (Q direction) in accordance with the second control mode. Also in this case, the second control mode is a control mode not including the process of pinching suppression such as the first control mode.

Specifically, the second control unit 21b rotates the second motor 6b by the second motor driving circuit 3b to move the backrest portion 32 from Y1 to the target position Y3 by the angle θb and stop the same at the target position Y3. Although the target position Y3 is close to the rear seat 40, the occupant 60 is not seated on the seat 40. Therefore, pinching of the occupant 60 does not occur in a state in which the backrest portion 32 is stopped at the target position Y3.

As described above, in the first embodiment, in case in which the backrest portion 32 performs a reclining operation, if the occupant 60 is seated on the rear seat 40 as shown in FIG. 3B, since the movement angle of the backrest portion 32 is limited to the small angle θa, the pinching of the occupant 60 between both the seats 30 and 40 can be suppressed. On the other hand, as shown in FIG. 3C, if the occupant 60 is not seated on the rear seat 40, pinching of the occupant 60 does not occur even if the backrest portion 32 moves to the target position Y3 by the large angle θb.

In the above description, an example is taken, in which the electric seat 30 is automatically driven by operating the first switches 11a and 11b to automatically move the seat portion 31 and the backrest portion 32 to the target positions X3 and Y3. However, even in a case in which the electric seat 30 is manually driven by operating the second switches 12a and 12b to move the seat portion 31 and the backrest portion 32 to arbitrary positions, it is possible to suppress pinching based on the same principle.

Specifically, if the occupant 60 is seated on the rear seat 40, even when the second switches 12a and 12b are being operated, the seat portion 31 and the backrest portion 32 are stopped when moved by a certain amount (the first control mode). Further, if the occupant 60 is not seated on the rear seat 40, the seat portion 31 and the backrest portion 32 are moved until the operation of the second switches 12a and 12b is cancelled (the second control mode).

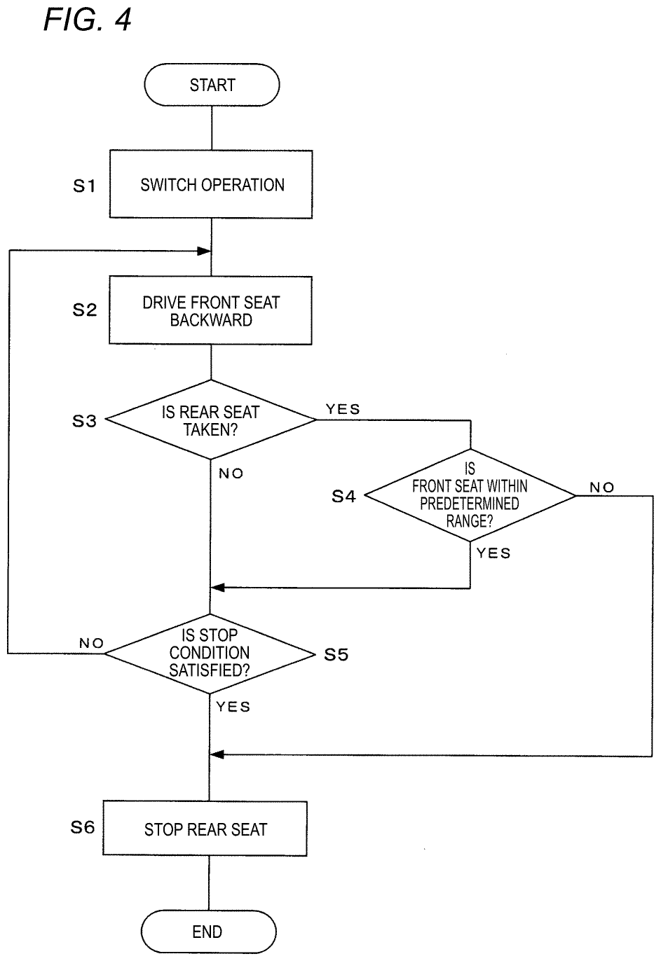

FIG. 4 is a flow chart showing a control procedure by the seat control device 2 of the first embodiment described above.

In step S1, a switch operation for moving the seat portion 31 or the backrest portion 32 in the backward direction R is performed in the sliding operation unit 1a or the reclining operation unit 1b. In the following step S2, under the control of the first control unit 21a or the second control unit 21b, the first motor driving circuit 3a or the second motor driving circuit 3b operates to rotate the first motor 6a or the second motor 6b, and the seat portion 31 or the backrest portion 32 of the front seat (electric seat 30) is driven backward (in the P direction or Q direction).

Next, in step S3, based on the detection result of the seating detection unit 23, it is determined whether or not the occupant 60 is seated on the rear seat 40. As a result of the determination, if the occupant 60 is not seated (step S3: NO), the process proceeds to step S5 and waits until a stop condition, which will be described later, is satisfied. On the other hand, in a case in which the occupant 60 is seated (step S3: YES), the process proceeds to step S4 to determine whether the position of the seat portion 31 or the backrest portion 32 of the front seat is within a predetermined range. For example, until the seat portion 31 reaches the position of X2 in FIG. 2B or until the backrest portion 32 reaches the position of Y2 in FIG. 3B, the position of the seat portion 31 and the backrest portion 32 is determined to be within a predetermined range.

If it is determined in step S4 that the position of the seat portion 31 or the backrest portion 32 is within the predetermined range (step S4: YES), the process proceeds to step S5. In step S5, it is determined whether or not a condition for stopping the seat portion 31 or the backrest portion 32 is satisfied. For example, in a case in which the seat portion 31 or the backrest portion 32 reaches the target position by the automatic operation, or in a case in which the manual operation is cancelled while the seat portion 31 or the backrest portion 32 is moving, it is determined that the stop condition is satisfied. Steps S2 to S5 are repeated until the stop condition is satisfied (step S5: NO).

If the stop condition is satisfied in step S5 (step S5: YES), the process proceeds to step S6. In step S6, the first motor 6a or the second motor 6b is stopped by the first control unit 21a or the second control unit 21b to stop the seat portion 31 or the backrest portion 32 of the front seat. Further, in a case in which it is determined in step S4 that the position of the seat portion 31 or the backrest portion 32 is not within the predetermined range (step S4: NO), the process proceeds to step S6 to stop the seat portion 31 or the backrest portion 32.

As described above, in the first embodiment, when the seat portion 31 and the backrest portion 32 move in the backward direction R, if the occupant 60 is seated on the rear seat 40, the movement amount of the seat portion 31 or the backrest portion 32 is limited. Therefore, the occupant 60 can be prevented from being pinched between both the seats 30 and 40. On the other hand, if the occupant 60 is not seated on the rear seat 40, even if the movement amount of the seat portion 31 or the backrest portion 32 is increased, the occupant 60 is not likely to be pinched.

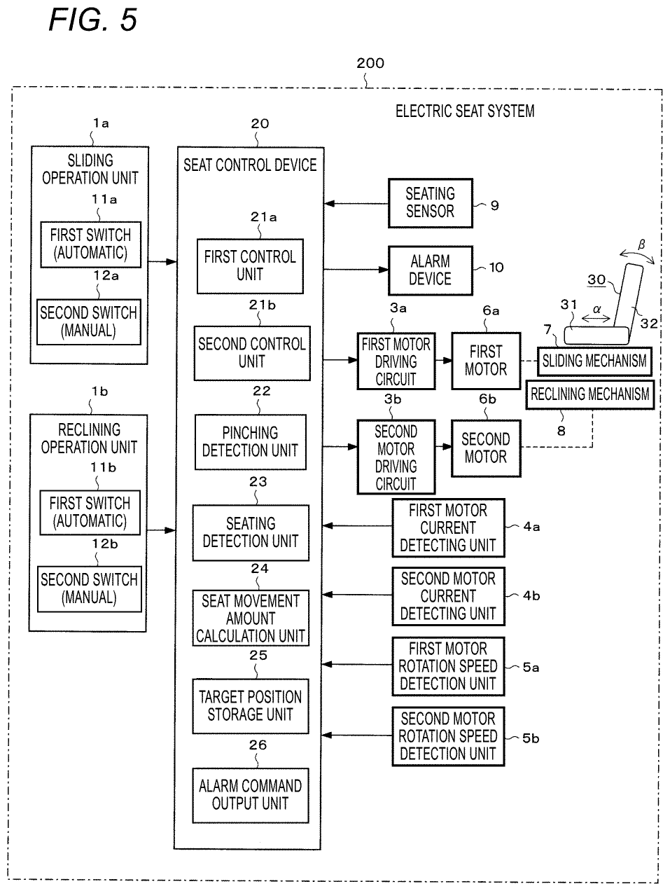

Next, a second embodiment of the present invention will be described. FIG. 5 shows a seat control device 20 according to the second embodiment of the present invention and an electric seat system 200 using the same. In FIG. 5, an alarm device 10 and an alarm command output unit 26 are added to the configuration of FIG. 1 of the first embodiment. The alarm device 10 is composed of a speaker, a buzzer, or the like, and is provided at a predetermined location inside the vehicle. The alarm command output unit 26 is provided in the seat control device 20. Since other configurations are the same as those in FIG. 1, description of the same parts as in FIG. 1 will be omitted.

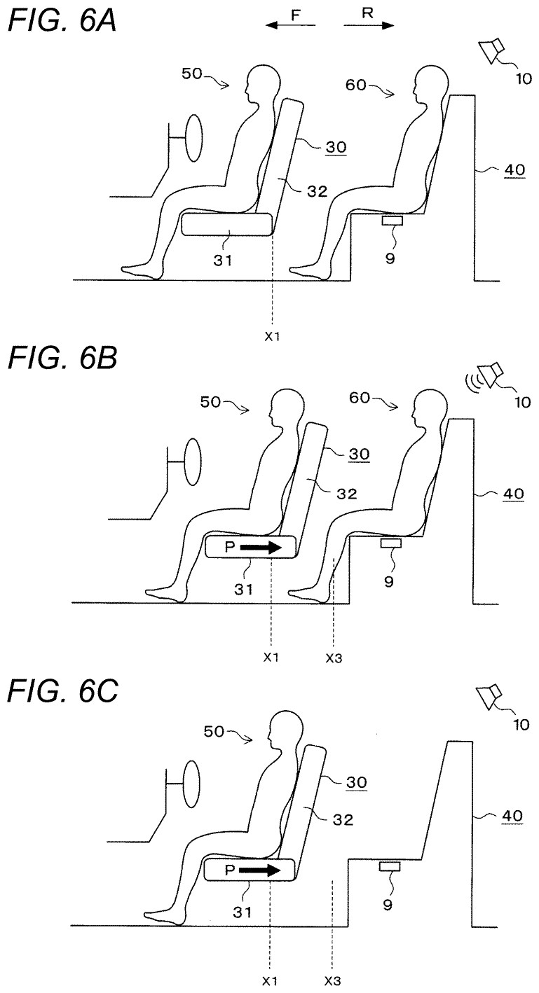

The details of the control in the second embodiment will be described below with reference to FIGS. 6A to 8.

FIGS. 6A to 6C show the operation when the seat portion 31 of the electric seat 30 moves. FIG. 6A shows the state before the sliding operation, in which the front electric seat 30 on which the occupant 50 is seated is positioned at a certain distance from the rear seat 40 on which the occupant 60 is seated. The position of the seat portion 31 at this time is assumed to be X1. In this state, when the occupant 50 operates the first switch 11a of the sliding operation unit 1a, the seat portion 31 moves toward the target position by the reclining operation. At this time, if the movement direction of the seat portion 31 is the backward direction R, that is, the direction of the rear seat 40, the modes of control differ depending on whether or not the occupant 60 is seated on the seat 40.

More specifically, as shown in FIG. 6B, in a case in which the occupant 60 is seated on the rear seat 40, a seating detection signal is output from the seating sensor 9, and the seating detection unit 23 detects that the occupant 60 is seated on the rear seat 40 based on this signal. Then, the first control unit 21a moves the seat portion 31 of the electric seat 30 in the direction of the rear seat 40 (P direction) in accordance with a first control mode. Also in the second embodiment, the first control mode is a control mode including the process for suppressing the occupant 60 from being pinched between the seats 30 and 40, but the content thereof is the same as in the first embodiment.

Specifically, in a case in which an alarm command is output to the alarm device 10 by the alarm command output unit 26 and an alarm sound is generated from the alarm device 10 to the occupant 60 on the rear seat 40, the first control unit 21a rotates the first motor 6a by the first motor driving circuit 3a to move the seat portion 31 from the position of X1 to the target position X3. During this period, since an alarm sound is continuously generated from the alarm device 10, it is possible for the occupant 60 on the rear seat 40 to avoid being pinched between both the seats 30 and 40 by correcting the posture or moving the seat.

On the other hand, as shown in FIG. 6C, in a case in which the occupant 60 is not seated on the rear seat 40, a seating detection signal is not output from the seating sensor 9, and the seating detection unit 23 does not detect that the occupant 60 is seated on the rear seat 40. Therefore, the first control unit 21a moves the seat portion 31 of the electric seat 30 in the direction of the rear seat 40 (P direction) in accordance with a second control mode. Also in the second embodiment, the second control mode is a control mode not including the process of pinching suppression, but the content thereof is different from that in the first embodiment.

Specifically, in a case in which an alarm command is not output from the alarm command output unit 26 to the alarm device 10 and the alarm device 10 does not generate an alarm sound, the first control unit 21a rotates the first motor 6a by the first motor driving circuit 3a to move the seat portion 31 from the position of X1 to the target position X3. The target position X3 is a position close to the rear seat 40, but the occupant 60 is not seated on the seat 40. Therefore, pinching of the occupant 60 does not occur in a state in which the seat portion 31 is stopped at the target position X3.

As described above, in the second embodiment, in a case in which the seat portion 31 slides, if the occupant 60 is seated on the rear seat 40 as shown in FIG. 6B, an alarm sound is generated from the alarm device 10 during the movement of the seat portion 31. Therefore, it is possible to urge the occupant 60 to take action to avoid being pinched. On the other hand, as shown in FIG. 6C, if the occupant 60 is not seated on the rear seat 40, the occupant 60 is not pinched even if the seat portion 31 moves to the target position X3.

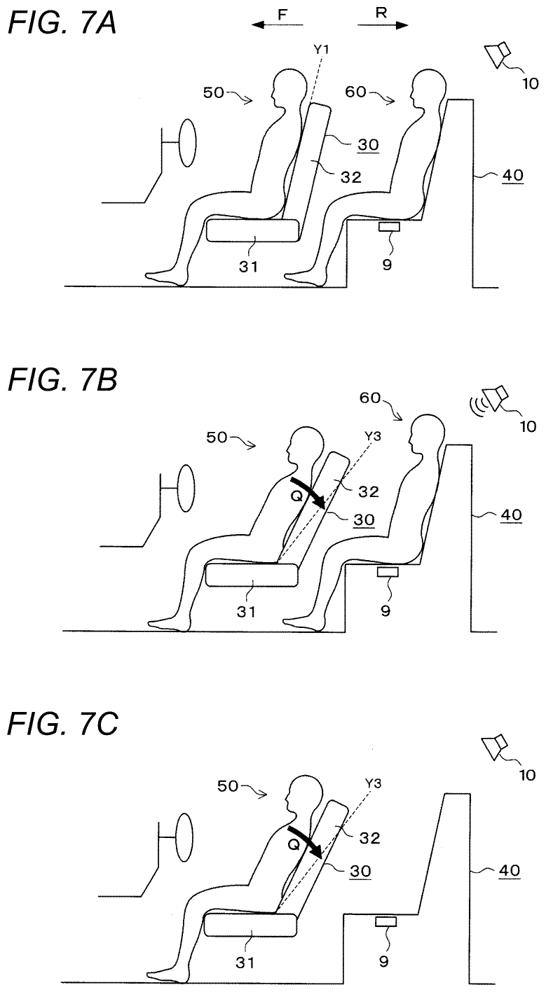

FIGS. 7A to 7C shows the operation in a case in which the backrest portion 32 of the electric seat 30 moves. FIG. 7A shows the state before the reclining operation, in which the front electric seat 30 on which the occupant 50 is seated is positioned at a certain distance from the rear seat 40 on which the occupant 60 is seated. The position of the backrest portion 32 at this time is assumed to be Y1. In this state, when the occupant 50 operates the first switch 11b of the reclining operation unit 1b, the backrest portion 32 moves toward the target position by the reclining operation. At this time, if the movement direction of the backrest portion 32 is the backward direction R, that is, the direction of the rear seat 40, the modes of control differ depending on whether or not the occupant 60 is seated on the seat 40.

More specifically, as shown in FIG. 7B, in a case in which the occupant 60 is seated on the rear seat 40, a seating detection signal is output from the seating sensor 9, and the seating detection unit 23 detects that the occupant 60 is seated on the rear seat 40 based on this signal. Then, the second control unit 21b moves the backrest portion 32 of the electric seat 30 in the direction of the rear seat 40 (Q direction) in accordance with the first control mode. Also in this case, the first control mode is a control mode including the process for suppressing the occupant 60 from being pinched between the seats 30 and 40, but the content thereof is the same as in the first embodiment.

Specifically, in a case in which an alarm command is output to the alarm device 10 by the alarm command output unit 26 and an alarm sound is generated from the alarm device 10 to the occupant 60 on the rear seat 40, the second control unit 21b rotates the second motor 6b by the second motor driving circuit 3b to move the backrest portion 32 from the position of Y1 to the target position Y3. During this period, since an alarm sound is continuously generated from the alarm device 10, it is possible for the occupant 60 on the rear seat 40 to avoid being pinched between both the seats 30 and 40 by correcting the posture or moving the seat.

On the other hand, as shown in FIG. 7C, in a case in which the occupant 60 is not seated on the rear seat 40, a seating detection signal is not output from the seating sensor 9, and the seating detection unit 23 does not detect that the occupant 60 is seated on the rear seat 40. Therefore, the second control unit 21b moves the backrest portion 32 of the electric seat 30 in the direction of the rear seat 40 (Q direction) in accordance with the second control mode. Also in the second embodiment, the second control mode is a control mode not including the process of pinching suppression, but the content thereof is different from that in the first embodiment.

Specifically, in a case in which an alarm command is not output from the alarm command output unit 26 to the alarm device 10 and the alarm device 10 does not generate an alarm sound, the second control unit 21b rotates the second motor 6b by the second motor driving circuit 3b to move the backrest portion 32 from the position of Y1 to the target position Y3. Although the target position Y3 is close to the rear seat 40, the occupant 60 is not seated on the seat 40. Therefore, pinching of the occupant 60 does not occur in a state in which the backrest portion 32 is stopped at the target position Y3.

As described above, in the second embodiment, in a case in which the backrest portion 32 reclines, if the occupant 60 is seated on the rear seat 40 as shown in FIG. 7B, an alarm sound is generated from the alarm device 10 during the movement of the backrest portion 32. Therefore, it is possible to urge occupant 60 to take action to avoid being pinched. On the other hand, as shown in FIG. 7C, if the occupant 60 is not seated on the rear seat 40, the occupant 60 is not pinched even if the backrest portion 32 moves to the target position Y3.

In the above description, an example is taken, in which the electric seat 30 is automatically driven by operating the first switches 11a and 11b to automatically move the seat portion 31 and the backrest portion 32 to the target positions X3 and Y3. However, even in a case in which the electric seat 30 is manually driven by operating the second switches 12a and 12b to move the seat portion 31 and the backrest portion 32 to arbitrary positions, it is possible to suppress pinching based on the same principle by urging the occupant 60 to take action to avoid being pinched.

Specifically, if the occupant 60 is seated on the rear seat 40, the alarm device 10 continue to output an alarm while the second switches 12a and 12b are operated, that is, during the movement of the seat portion 31 and the backrest portion 32 (the first control mode). If no occupant 60 is seated on the rear seat 40, the seat portion 31 or the backrest portion 32 is moved until the operations of the second switches 12a and 12b are cancelled without issuing an alarm from the alarm device 10 (the second control mode).

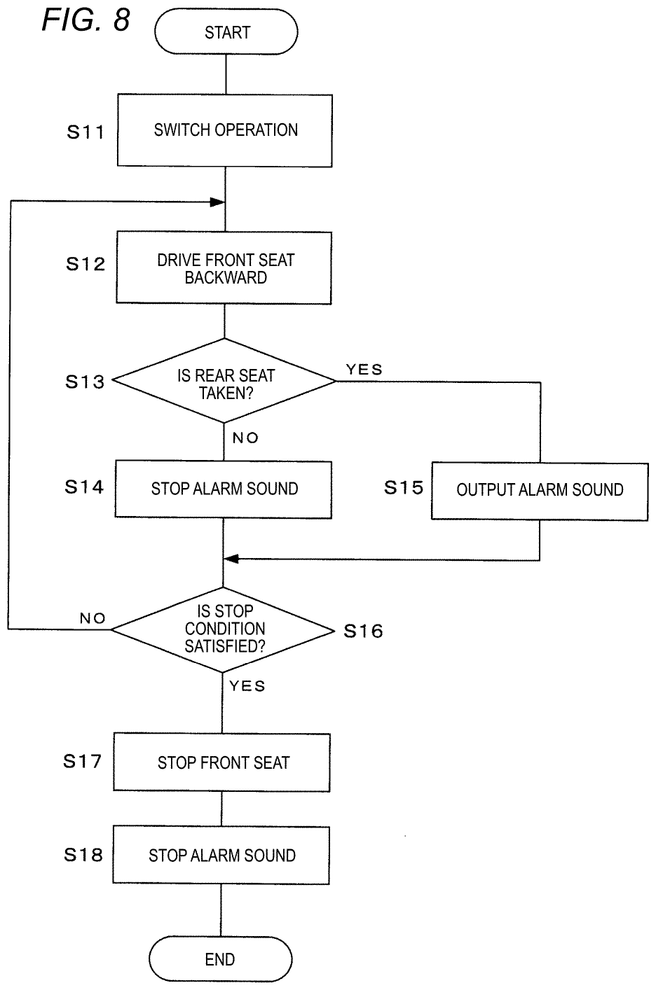

FIG. 8 is a flow chart showing a control procedure by the seat control device 20 of the second embodiment described above.

In step S11, a switch operation for moving the seat portion 31 or the backrest portion 32 in the backward direction R is performed in the sliding operation unit 1a or the reclining operation unit 1b. In the subsequent step S12, under the control of the first control unit 21a or the second control unit 21b, the first motor driving circuit 3a or the second motor driving circuit 3b operates to rotate the first motor 6a or the second motor 6b, and the seat portion 31 or the backrest portion 32 of the front seat (electric seat 30) is driven backward (in the P direction or Q direction).

Next, in step S13, based on the detection result of the seating detection unit 23, it is determined whether or not the occupant 60 is seated on the rear seat 40. As a result of the determination, in a case in which the occupant 60 is not seated (step S13: NO), the process proceeds to step S16 without outputting an alarm sound in step S14, and waits for the stop condition described later to be satisfied. On the other hand, in a case in which the occupant 60 is seated (step S13: YES), the process proceeds to step S15, and the alarm device 10 outputs an alarm sound based on the alarm command from the alarm command output unit 26.

In a state in which this alarm sound is being output, it is determined in step S16 whether or not a condition for stopping the seat portion 31 or the backrest portion 32 is satisfied. For example, in a case in which the seat portion 31 or the backrest portion 32 reaches the target position by the automatic operation, or in a case in which the manual operation is cancelled while the seat portion 31 or the backrest portion 32 is moving, it is determined that the stop condition is satisfied. Steps S12 to S16 are repeated until the stop condition is satisfied (step S16: NO). During this time, in a case in which the occupant on the rear seat 40 changes seats or gets off the vehicle, the determination in step S13 becomes NO, and the alarm sound of the alarm device 10 is stopped in step S14.

If the stop condition is satisfied in step S16 (step S16: YES), the process proceeds to step S17. In step S17, the first motor 6a or the second motor 6b is stopped by the first control unit 21a or the second control unit 21b to stop the seat portion 31 or the backrest portion 32 of the front seat. Then, in step S18, the alarm command output unit 26 stops outputting an alarm command, and the alarm sound from the alarm device 10 stops.

As described above, in the second embodiment, when the seat portion 31 or the backrest portion 32 moves in the backward direction R, if the occupant 60 is seated on the rear seat 40, an alarm sound is output from the alarm device 10. Therefore, it is possible to urge the occupant 60 to take action to avoid being pinched, thereby suppressing the occupant 60 from being pinched between the seats 30 and 40. On the other hand, if the occupant 60 is not seated on the rear seat 40, the occupant 60 is not likely to be pinched even if an alarm sound is not output.

In one or more embodiments of the present invention, various embodiments as described below can be adopted in addition to the embodiments described above.

In the above embodiment, the sliding operation of the seat portion 31 and the reclining operation of the backrest portion 32 are described separately, but one or more embodiments of the invention can also be applied in a case in which the sliding operation of the seat portion 31 and the reclining operation of the backrest portion 32 are performed in parallel.

In the above embodiment, the pinching between the front seat 30 and the rear seat 40 adjacent to the front seat 30 is taken as an example, but the present invention is not limited thereto. For example, in a vehicle equipped with three rows of seats, a front seat, a middle seat, and a rear seat, one or more embodiments of the present invention can also be applied to the pinching between the front seat and the middle seat adjacent thereto or between the middle seat and the rear seat adjacent thereto. Also, the front seat is not limited to the driver's seat, and may be the assistant seat.

In the above embodiment, an example of avoiding pinching of the legs of the occupant 60 on the rear seat is taken, but one or more embodiments of the present invention are also effective in avoiding the pinching of a luggage placed on the rear seat 40. In this case, the seating sensor 9 is composed of a pressure sensor as described above, and since the pressure sensor can detect the weight of an object, the seating sensor 9 detects that a luggage is placed on the rear seat 40.

In the above embodiment, an example using a pressure sensor as the seating sensor 9 is taken, but the present invention is not limited thereto. For example, a heartbeat sensor, a blood pressure sensor, or the like provided in the seat 40 for monitoring the health condition of the occupant 60 may be used as the seating sensor 9. As another means, whether or not the occupant 60 is seated may be detected based on an image captured by a monitoring camera installed in the vehicle.

In the above embodiment, an example of using the alarm sound output from the alarm device 10 to alert the occupant 60 on the rear seat is taken, but in place of the sound (or in addition to the sound), for example, the light emission of a lamp may be used to alert the occupant 60.

In the embodiment described above, in FIGS. 1 and 5, the motor driving circuits 3a and 3b are provided outside the seat control devices 2 and 20, but these motor driving circuits 3a and 3b may be included in the seat control devices 2 and 20. The seat control devices 2 and 20 may also include the motor current detecting units 4a and 4b, the motor rotation speed detection units 5a and 5b, the seating sensor 9, and the like.

In the above-described embodiments, the seat control device mounted on the vehicle is taken as an example, but one or more embodiments of the present invention can also be applied to seat control devices used in fields other than vehicles.

While the invention has been described with respect to a limited number of embodiments, those skilled in the art, having benefit of this disclosure, will appreciate that other embodiments can be devised which do not depart from the scope of the invention as disclosed herein. According, the scope of the invention should be limited only by the attached claims.

1. A seat control device that is a control device of an electric seat configured to move to a predetermined position based on a predetermined operation, the seat control device comprising:
a control unit configured to control movement of the electric seat in a front-and-rear direction; and
a seating detection unit configured to detect whether or not an occupant is seated on another seat in front of or behind the electric seat, the other seat being adjacent to the electric seat,
wherein when the electric seat moves in a direction of the other seat, in a case in which the seating detection unit detects that the occupant is seated on the other seat, the control unit moves the electric seat in the direction of the other seat in a first control mode that includes a process for suppressing the occupant from being pinched between the electric seat and the other seat, and
wherein when the electric seat moves in the direction of the other seat, in a case in which the seating detection unit does not detect that the occupant is seated on the other seat, the control unit moves the electric seat in the direction of the other seat in a second control mode that does not include the process.

2. The seat control device according to claim 1,
wherein the control unit comprises a first control unit configured to control an operation of a seat portion provided in the electric seat, the seat portion being configured to move straight in the front-and-rear direction,
wherein when the seat portion moves in the direction of the other seat, in a case in which the seating detection unit detects that the occupant is seated on the other seat, the first control unit moves the seat portion in the direction of the other seat by a distance smaller than a predetermined distance in accordance with the first control mode, and
wherein when the seat portion moves in the direction of the other seat, in a case in which the seating detection unit does not detect that the occupant is seated on the other seat, the first control unit moves the seat portion in the direction of the other seat by the predetermined distance in accordance with the second control mode.

3. The seat control device according to claim 1,
wherein the control unit comprises a second control unit configured to control an operation of a backrest portion provided in the electric seat, the backrest portion being configured to tilt in the front-and-rear direction,
wherein when the backrest portion moves in the direction of the other seat, in a case in which the seating detection unit detects that the occupant is seated on the other seat, the second control unit moves the backrest portion in the direction of the other seat by an angle smaller than a predetermined angle in accordance with the first control mode, and
wherein when the backrest portion moves in the direction of the other seat, in a case in which the seating detection unit does not detect that the occupant is seated on the other seat, the second control unit moves the backrest portion in the direction of the other seat by the predetermined angle in accordance with the second control mode.

4. The seat control device according to claim 1, further comprising:
an alarm command output unit configured to issue an alarm to the occupant seated on the other seat,
wherein the control unit comprises a first control unit configured to control an operation of a seat portion provided in the electric seat, the seat portion being configured to move straight in the front-and-rear direction,
wherein when the seat portion moves in the direction of the other seat, in a case in which the seating detection unit detects that the occupant is seated on the other seat, the first control unit moves the seat portion in the direction of the other seat in a state in which the alarm is issued by the alarm command output unit in accordance with the first control mode, and
wherein when the seat portion moves in the direction of the other seat, in a case in which the seating detection unit does not detect that the occupant is seated on the other seat, the first control unit moves the seat portion in the direction of the other seat without issuing the alarm by the alarm command output unit in accordance with the second control mode.

5. The seat control device according to claim 1, further comprising:
an alarm command output unit configured to issue an alarm to the occupant seated on the other seat,
wherein the control unit comprises a second control unit configured to control an operation of a backrest portion provided in the electric seat, the backrest portion being configured to tilt in the front-and-rear direction,
wherein when the backrest portion moves in the direction of the other seat, in a case in which the seating detection unit detects that the occupant is seated on the other seat, the second control unit moves the backrest portion in the direction of the other seat in a state in which the alarm is issued by the alarm command output unit in accordance with the first control mode, and
wherein when the backrest portion moves in the direction of the other seat, in a case in which the seating detection unit does not detect that the occupant is seated on the other seat, the second control unit moves the backrest portion in the direction of the other seat without issuing the alarm by the alarm command output unit in accordance with the second control mode.

6. A seat control method that is a control method of an electric seat configured to move to a predetermined position based on a predetermined operation, the seat control method comprising:
detecting whether or not an occupant is seated on another seat in front of or behind the electric seat, the other seat being adjacent to the electric seat;
moving the electric seat in a direction of the other seat in a first control mode that includes a process for suppressing the occupant from being pinched between both the seats when the electric seat moves in the direction of the other seat and in a case in which it is detected that the occupant is seated on the other seat; and
moving the electric seat in the direction of the other seat in a second control mode that does not include the process when the electric seat moves in the direction of the other seat and in a case in which it is not detected that the occupant is seated on the other seat.
